(19) United States
(12) Patent Application Publication
(10) Pub. No.: US 2012/0267204 A1
(43) Pub. Date: Oct. 25, 2012

(54) SHOCK ABSORBER

(75) Inventor: Kesatoshi TAKEUCHI, Shiojiri (JP)

(73) Assignee: SEIKO EPSON CORPORATION, Tokyo (JP)

(21) Appl. No.: 13/541,243

(22) Filed: Jul. 3, 2012

Related U.S. Application Data
(63) Continuation of application No. 12/393,579, filed on Feb. 26, 2009.

(30) Foreign Application Priority Data
Mar. 18, 2008 (JP) 2008-069250

(51) Int. Cl. F16F 15/03

(52) U.S. Cl. 188/267

(57) ABSTRACT

The shock absorber includes N magnets arranged such that like poles of adjacent magnets face each other to generate repulsive force, where N is an integer of al least 2; and a magnet holder that accommodates the N magnets such that a distance between the adjacent magnets is variable, whereby the shock absorber absorbs a shock applied to two end magnets disposed at respective ends of the N magnets.

### CROSS-REFERENCE TO RELATED APPLICATIONS

This is a continuation application of U.S. Ser. No. 12/393,579 filed Feb. 26, 2009, which claims priority to Japanese Patent Application No. 2008-69250 filed on Mar. 18, 2008, the contents of which are incorporated herein by reference in their entireties.

### BACKGROUND OF THE INVENTION

1. Field of the Invention

The present invention relates to shock absorber.

2. Description of the Related Art

Some conventional shock absorbers use a spring for absorbing a shock (see, for example, JP2007-269271A).

There have been highly demanded development of a non-mechanical shock-absorbing system, weight reduction of the shock absorber, efficient control of the shock-absorbing performance, and regeneration of the shock-absorbing energy.

### SUMMARY

An object of the present invention is to provide a shock absorber technology that is significantly different from the prior art technique.

According to an aspect of the present invention, a shock absorber is provided. The shock absorber comprises: N magnets arranged such that like poles of adjacent magnets face each other to generate repulsive force, where N is an integer of al least 2; and a magnet holder that accommodates the N magnets such that a distance between the adjacent magnets is variable, whereby the shock absorber absorbs a shock applied to two end magnets disposed at respective ends of the N magnets.

According to this configuration, the repulsive force of the like poles of the adjacent magnets to absorb a shock.

The present invention is not restricted to the shock absorber having any of the above arrangements but may be actualized by diversity of other applications, for example, a shock-absorbing method, a shock-absorbing system, computer programs configured to implement the functions of the shock absorber and the shock absorber method, and recording media in which such computer programs are recorded.

### BRIEF DESCRIPTION OF THE DRAWINGS

FIGS. 1A and 1B schematically illustrate the structure of a shock absorber in a first embodiment of the invention;

FIG. 2 shows a magnetizing direction of the magnets in the shock absorber of the first embodiment;

FIG. 3 schematically illustrates the structure of a shock absorber in a second embodiment of the invention;

FIG. 4 schematically illustrates the structure of a shock absorber in a third embodiment of the invention;

FIG. 5 schematically illustrates the structure of a shock absorber in a fourth embodiment of the invention;

FIGS. 6A and 6B schematically illustrate the structure of a shock absorber in a fifth embodiment of the invention;

FIGS. 7A and 7B show a sensor output variation and an exemplified structure of the position sensor in the fifth embodiment;

FIGS. 8A and 8B show the schematic structure of a drive controller provided for the electromagnetic coil in the fifth embodiment;

FIG. 9 schematically illustrates the structure of a shock absorber in a sixth embodiment of the invention;

FIG. 10 is a block diagram schematically illustrating the structure of a shock-absorbing power generation apparatus in a seventh embodiment of the invention;

FIGS. 11A-11E show the internal structure and the operations of the drive controller;

FIG. 12 is a block diagram showing the internal structure of the command value setting module;

FIG. 13 is a block diagram showing the internal structure of the buffer module;

FIG. 14 is a graph showing variations in shock-absorbing performance with regard to the bias high current and the bias low current;

FIG. 15 is a circuit diagram showing the internal structure of the power storage controller;

### DESCRIPTION OF THE PREFERRED EMBODIMENT

Next, aspects of the present invention will be described in the following order on the basis of embodiments:
A. First to Fourth Embodiments (no control circuit):
B. Fifth Embodiment
C. Sixth Embodiment
D. Seventh Embodiment
E. Modifications:

### A. First to Fourth Embodiments

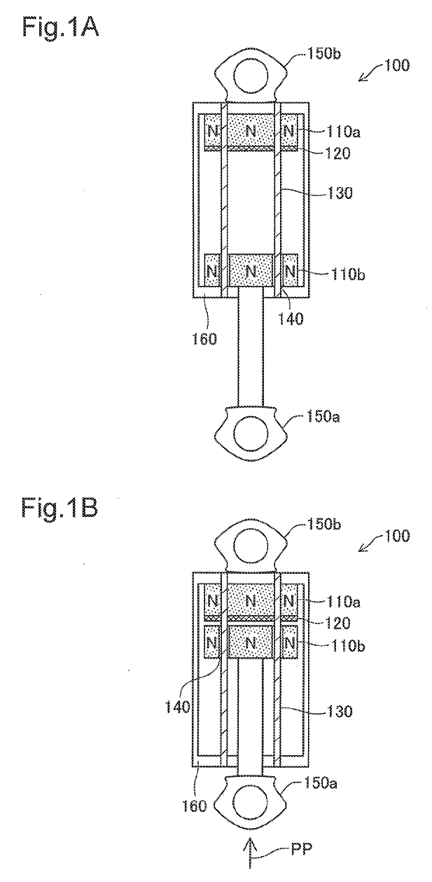

FIGS. 1A and 1B schematically illustrate the structure of a shock absorber 100 in a first embodiment of the invention. The shock absorber 100 has two permanent magnets 110a and 110b and a magnet holder 160 constructed to support the magnets 110a and 110b. The first magnet 110a is fastened to an upper end of the magnet holder 160, while the second magnet 110b is provided to be freely movable in a vertical direction in the magnet holder 160. A guide member 130 is provided in the magnet holder 160 to guide the second magnet 110b in the vertical direction. A cushion member 120 is provided on a lower end of the first magnet 110a to protect the first magnet 110a from a potential damage caused by a collision with the second magnet 110b. A lower end of the second magnet 110b is connected to a load connector 150a, while another load connector 150b is provided on an upper end of the magnet holder 160. Either one of the guide member 130 and the magnet holder 160, as well as the cushion member 120 may be omitted when not required.

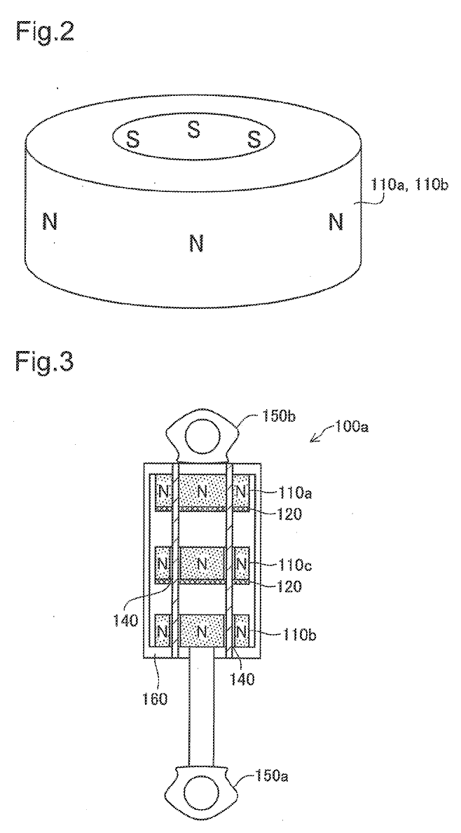

FIG. 2 shows a magnetizing direction of the magnets 110a and 110b in the shock absorber 100 of the first embodiment. Each of the magnets 110a and 110b is formed in a ring shape and is magnetized to have an N pole on its outer circumference and an S pole on its inner circumference. In the state of FIG. 1A, the like poles of the two magnets 110a and 110b repel each other, so as to make the two magnets 110a and 110b sufficiently away from each other. In the state of FIG. 1B, application of a shock PP to the load connector 150a presses the second magnet 110b toward the first magnet 110a. The repulsive force is increased between like poles of the two magnets 110b and 110c accordingly to absorb the shock PP.

The shock absorber 100 of the first embodiment absorbs a shock by taking advantage of the repulsive force of magnets that are substantially not in contact with each other. This arrangement ensures the damage-resistant structure of the shock absorber and facilitates size reduction of the shock absorber.

FIG. 3 schematically illustrates the structure of a shock absorber 100a in a second embodiment of the invention. The difference from the shock absorber 100 of the first embodiment shown in FIGS. 1A and 1B is that a middle magnet 110c is added between the two magnets 110a and 110b. Otherwise the structure of the shock absorber 100a of the second embodiment is the same with the structure of the shock absorber 100 of the first embodiment. The middle magnet 110c is not fixed but is only guided by the guide member 130 within the magnet holder 160. The middle magnet 110c is accordingly constructed as a floating magnet that is freely movable in the vertical direction in the magnet holder 160.

Like the shock absorber 100 of the first embodiment, the shock absorber 100a of the second embodiment having the floating magnet disposed between the two magnets absorbs a shock by taking advantage of the repulsive force of the like poles of the magnet. Instead of one floating magnet, multiple floating magnets may be used to absorb a shock by taking advantage of the repulsive force of magnets having the intensity in proportion to the number of the multiple floating magnets.

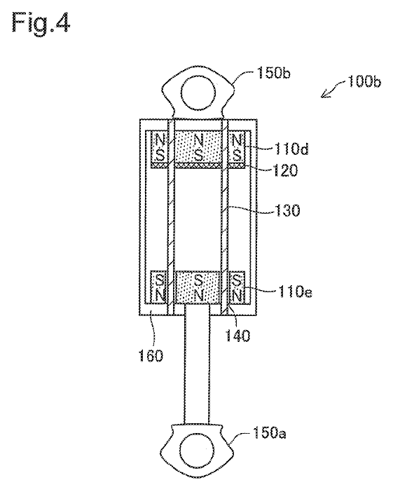

FIG. 4 schematically illustrates the structure of a shock absorber 100b in a third embodiment of the invention. The differences from the shock absorber 100 of the first embodiment shown in FIGS. 1A and 1B are the magnetizing directions of magnets 110d and 110e. Otherwise the structure of the shock absorber 100b of the third embodiment is the same with the structure of the shock absorber 100 of the first embodiment. Each of the magnets 110d and 110e is formed in a ring shape and is magnetized in the vertical direction to have an N pole on its upper end and an S pole on its lower end.

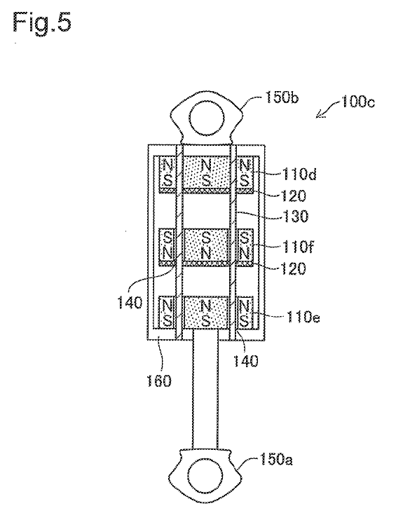

FIG. 5 schematically illustrates the structure of a shock absorber 100c in a fourth embodiment of the invention. The difference from the shock absorber 100a of the second embodiment shown in FIG. 3 is the magnetizing direction of magnets 110d to 110f. Otherwise the structure of the shock absorber 100c of the fourth embodiment is the same with the structure of the shock absorber 100a of the second embodiment. Each of the magnets 110d, 110e, and 110f is magnetized in the vertical direction to have an N pole on its upper end and an S pole on its lower end as in the third embodiment.

The shock absorbers 100b and 100c of the third and the fourth embodiments also effectively absorb a shock by taking advantage of the repulsive force of magnets that are magnetized in the different direction from that of the shock absorbers 100 and 100a of the first and the second embodiments. The shock absorbers 100b and 100c of the third and the fourth embodiments allow generation of a greater resistance force, compared with the shock absorbers 100 and 100a of the first and the second embodiments.

### B. Fifth Embodiment

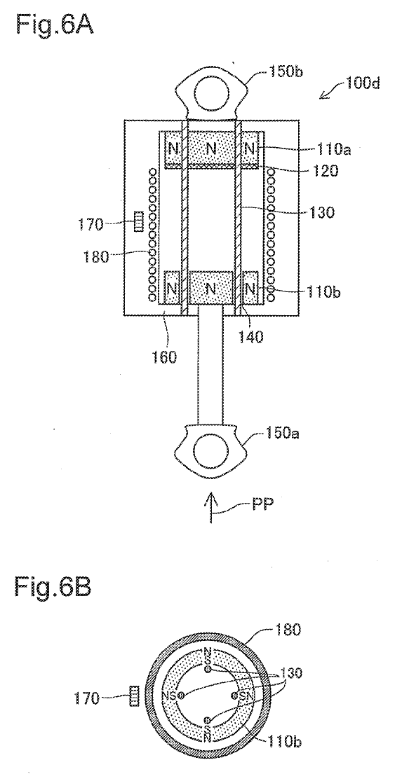

FIGS. 6A and 6B schematically illustrate the structure of a shock absorber 100d in a fifth embodiment of the invention. FIG. 6A is a vertical sectional view of the shock absorber 100d. The difference from the shock absorber 100 of the first embodiment shown in FIGS. 1A and 1B is that there are added a position sensor 170 and an electromagnetic coil 180 for generating a buffering. Otherwise the structure of the shock absorber 100d of the fifth embodiment is the same with the structure of the shock absorber 100 of the first embodiment. The position sensor 170 is provided inside the magnet holder 160 to be disposed between the magnets 110a and 110b. The electromagnetic coil 180 is also provided inside the magnet holder 160 to be extended between the lower end of the first magnet 110a to the second magnet 110b.

FIG. 6B is a horizontal sectional view of the shock absorber 100d. The electromagnetic coil 180 is provided to be spirally wound on the outer circumference of the ring-shaped magnet 110b. The electromagnetic coil 180 may alternatively be arranged along the inner circumference of the permanent magnet 110b or may be arranged along both the inner circumference and the outer circumference of the permanent magnet 110b. The position sensor 170 constructed by a magnetic sensor, such as a Hall element, is provided outside the electromagnetic coil 180. A coil sensor may be applied for the position sensor 170. The position sensor 170 may be omitted when not required.

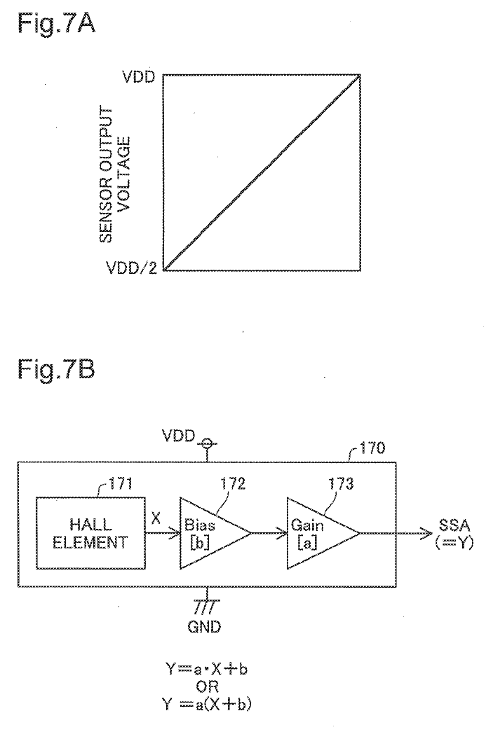

FIGS. 7A and 7B show a sensor output variation and an exemplified structure of the position sensor 170 in the fifth embodiment. FIG. 7A is a graph showing a variation in output of the position sensor 170. The induced voltage detected by the position sensor 170 increases with a decrease in distance between the magnet 110b and the position sensor 170. FIG. 7B shows one example of the internal structure of the position sensor 170. The position sensor 170 includes a Hall element 171, a bias adjustor 172, and a gain adjustor 173. The Hall element 171 measures a magnetic flux density and outputs the measured magnetic flux density as X. The bias adjustor 172 adds a bias value ‘b’ to the output X of the Hall element 171. The gain adjustor 173 multiplies the output X of the Hall element 171 by a gain value ‘a’. A resulting sensor output SSA (=Y) of the position sensor 170 is given by, for example, Equation (1) or Equation (2) below:

Y=a·X+b (1)

Y=a(X+b) (2)

Setting adequate values to the gain value ‘a’ and the bias value ‘b’ of the position sensor 170 calibrates the sensor output SSA to a desired shape.

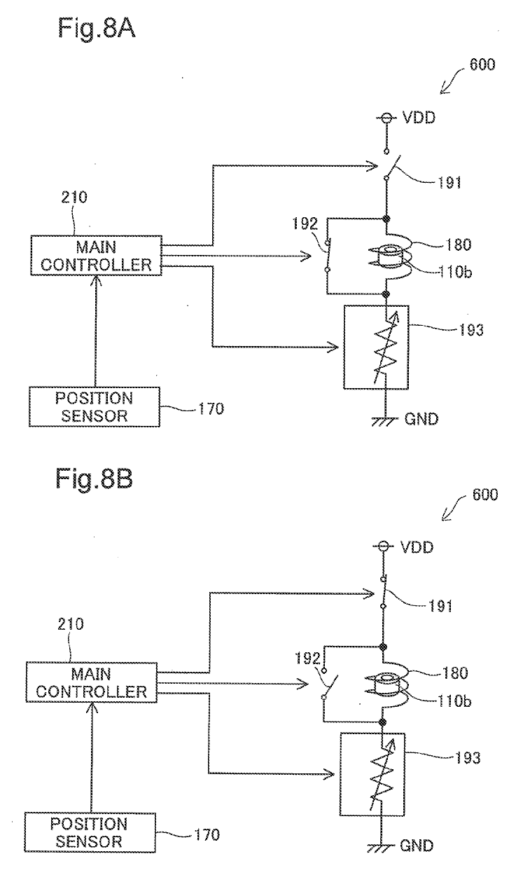

FIGS. 8A and 8B show the schematic structure of a drive controller 600 provided for the electromagnetic coil 180 in the fifth embodiment. The drive controller 600 includes a main controller 210, two switches 191 and 192, and a variable resistor 193, in addition to the position sensor 170 and the electromagnetic coil 180 discussed above. The first switch 191, the electromagnetic coil 180, and the variable resistor 193 are connected in series between a power supply potential VDD and a ground potential GND. The second switch 192 is connected in parallel to the electromagnetic coil 180.

In the state of FIG. 8A, setting the first switch 191 OFF and the second switch 192 ON short-circuits the electromagnetic coil 180. The resulting short-circuit braking function applies a braking force onto the second magnet 110b. In the state of FIG. 8B, on the other hand, setting the first switch 191 ON and the second switch 192 OFF causes electric current to flow through the electromagnetic coil 180 and applies a downward force onto the second magnet 110b. The intensity of the electric current flowing through the electromagnetic coil 180 is adjustable by the variable resistor 193. The main controller 210 controls the switching operations of the first switch 191 and the second switch 192 and sets a resistance value Rv in the variable resistor 193, based on the detection result of the position sensor 170. In one preferable application, an internal memory of the main controller 210 stores a table of the resistance value Rv correlated to the detection result of the position sensor 170.

The arrangement of the electromagnetic coil along the outer circumference or the inner circumference of the magnets effectively utilizes the force of the electromagnetic coil applied to the magnet, as well as the repulsive force of magnets, to absorb a shock. The structure of the fifth embodiment accordingly gives a greater resistance force, compared with the structure of the first embodiment.

### C. Sixth Embodiment

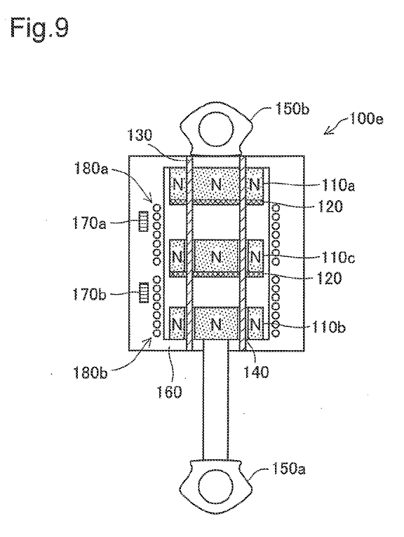

FIG. 9 schematically illustrates the structure of a shock absorber 100e in a sixth embodiment of the invention. The primary difference from the shock absorber 100d of the fifth embodiment shown in FIG. 6A is addition of a middle magnet (floating magnet) 110c between the two magnets 110a and 110b. In the shock absorber 100e of the sixth embodiment, two position sensors 170a and 170b and two electromagnetic coils 180a and 180b are provided corresponding to the two movable magnets 110b and 110c. The first electromagnetic coil 180a is extended along the outer circumference of the lower end of the upper end magnet 110a to the middle magnet 110c in the state of FIG. 9 where the two magnets 110a and 110c are most distant from each another. The second electromagnetic coil 180b is extended along the outer circumference of the lower end of the middle magnet 110c to the lower end magnet 110b. The extension range of the electromagnetic coils 180 may be determined arbitrarily. For example, the electromagnetic coils 180 may be provided corresponding to the movable ranges of the respective magnets 110b and 110c.

The addition of the floating magnet between the two magnets and the extension of the electromagnetic coils corresponding to the floating magnet effectively utilize the force of the multiple electromagnetic coils applied to the magnets, as well as the repulsive force of magnets, to absorb a shock.

### D. Seventh Embodiment

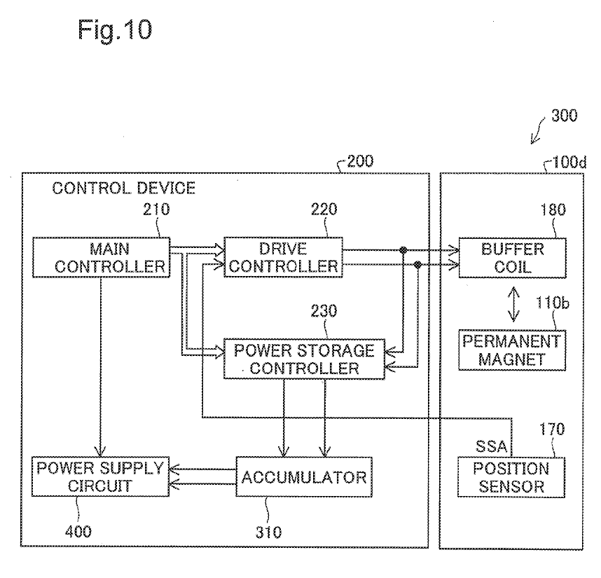

FIG. 10 is a block diagram schematically illustrating the structure of a shock-absorbing power generation apparatus 300 in a seventh embodiment of the invention. The shock-absorbing power generation apparatus 300 includes a control device 200 and a shock absorber 100d. The shock absorber 100d is identical with the shock absorber 100d of the fifth embodiment shown in FIGS. 6A and 6B. The shock absorber 100d may be replaced with the shock absorber 100e of the sixth embodiment shown in FIG. 9. The control device 200 includes a main controller 210, a drive controller 220, a power storage controller 230, an electricity accumulator 310, and a power supply circuit 400. The drive controller 200 functions to supply electric current to the electromagnetic coil 180 and thereby adjust the shock-absorbing performance. The power storage controller 230 functions to charge the accumulator 310 with the electric power generated in the electromagnetic coil 180 due to movement of the permanent magnet 110b. The accumulator 310 may be a secondary battery or a capacitor.

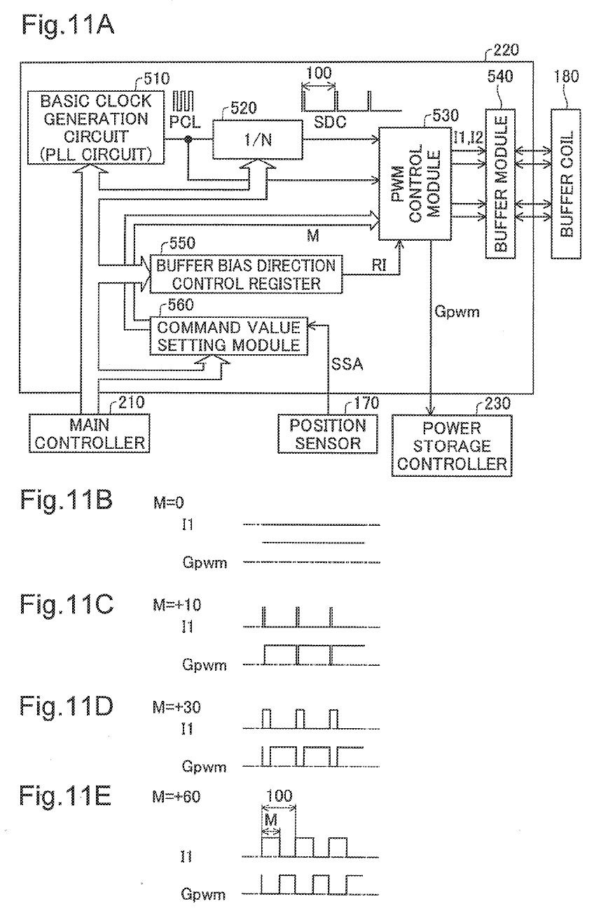

FIGS. 11A-11E show the internal structure and the operations of the drive controller 220. FIG. 11A shows the internal structure of the drive controller 220. The drive controller 220 includes a basic clock generation circuit 510, a frequency divider 520, a PWM control module 530, a buffer module 540, a buffer bias direction control register 550, and a command value setting module 560.

The basic clock generation circuit 510 generates a clock signal PCL of a preset frequency, which may include, a PLL circuit. The frequency divider 520 generates a clock signal SDC having a 1/N frequency of the clock signal PCL. The value N is a fixed value and is set in advance in the frequency divider 520 by the main controller 210. A value RI representing a flow direction of electric current through the electromagnetic coil 180 is set in advance in the buffer bias direction control register 550 by the main controller 210.

The command value setting module 560 sets a command value M, based on the detection result of the position sensor 170. The command value M is used to determine the duty cycles of drive signals generated by the PWM controller 530. The PWM control module 530 generates drive signals I1 and 12 and a power storage enable signal Gpwm, based on the clock signals PCL and SDC, the value RI supplied from the buffer bias direction control register 550, and the command value M supplied from the command value setting module 560. This operation is discussed more in detail below. The buffer module 540 is an H bridge circuit of controlling the electric current flowing through the electromagnetic coil 180 based on the drive signals I1 and 12 generated by the PWM control module 530.

FIGS. 11B through 11E show the operations of the PWM control module 530 at various values set to the command value M. The PWM control module 530 is a circuit of generating one pulse having a duty cycle of M/N in each period of the clock signal SDC. As clearly understood from the comparison of FIGS. 11B through 11E, the duty cycles of the pulses of the driving signal I1 and I2 and the power storage enable signal Gpwm increase with an increase in command value M. The first drive signal I1 works to make the electric current flow in a specific direction through the electromagnetic coil 180, and the second drive signal I2 works to make the electric current flow in an opposite direction through the electromagnetic coil 180. FIGS. 11B through 11E show the pulse variations of only the first drive signal I1 as a representative example. The power storage enable signal Gpwm works to give a power storage command to the power storage controller 230. As clearly understood from FIGS. 11B through 11E, the drive signal I1 (or the drive signal I2) is exclusive to the power storage enable signal Gpwm.

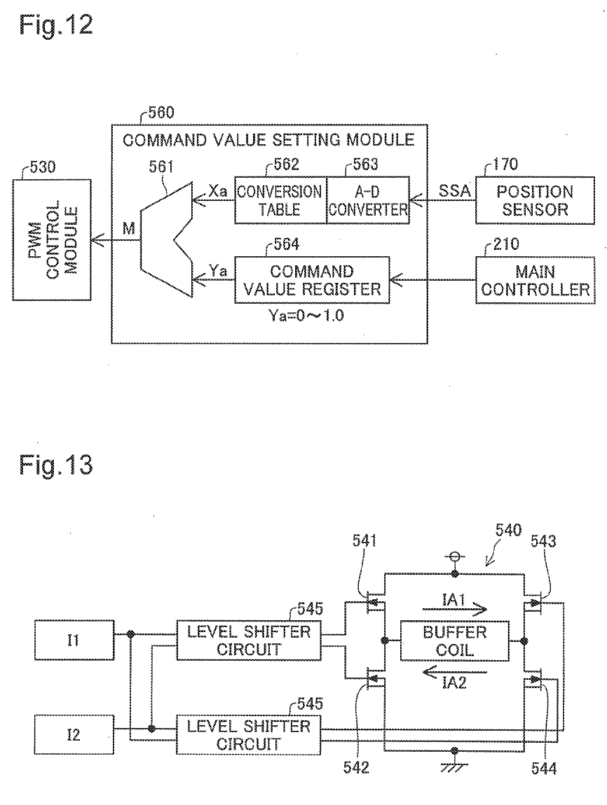

FIG. 12 is a block diagram showing the internal structure of the command value setting module 560. The command value setting module 560 includes a multiplier 561, a conversion table 562, an A-D converter 563, and a command value register 564. The output SSA of the position sensor 170 is supplied to the A-D converter 563. The A-D converter 563 performs analog-to-digital conversion and converts the sensor output SSA into a digital sensor output. The range of the digital sensor output from the A-D converter 563 is, for example, FFh to 0h, where ‘h’ represents hexadecimal notation. The conversion table 562 is used to introduce a variable signal value Xa from the digital sensor output. The variable signal value Xa functions to determine a voltage to be applied to the electromagnetic coil 180. The variable signal value Xa read out from the conversion table 562 varies in time series. The conversion table 562 is preferably designed to introduce the variable signal value Xa for ensuring an optimum output of the electromagnetic coil 180 according to the distance between the magnet 110b and the magnet 110a. The variable signal value Xa may be calculated by function computation.

The command value register 564 stores a command value Ya set by the main controller 210. The command value Ya functions to determine a voltage to be applied to the electromagnetic coil 180. The command value Ya is typically set in a range of 0 to 1.0 but may be a value of greater than 1.0 according to the requirements. The following description is on the assumption that the command value Ya is set in the range of 0 to 1.0. Here Ya=0 represents that the applied voltage is zero, and Ya=1.0 represents that the applied voltage is a maximum possible value. The multiplier 561 multiplies the variable signal value Xa by the command value Ya, rounds the product to an integer, and supplies the rounded product as the command value M to the PWM control module 530.

The PWM control module 530 is constructed as a PWM control circuit to make the input command value M subjected to PWM control and accordingly generate a PWM signal. By adjusting the command value Ya, the PWM control module 530 generates the PWM signal simulating a waveform in proportion to the sensor output SSA and having an effective amplitude corresponding to the level of the command value Ya. This arrangement facilitates generation of the appropriate PWM signal according to the sensor output SSA of the position sensor 170.

FIG. 13 is a block diagram showing the internal structure of the buffer module 540. The buffer module 540 is an H bridge circuit having four switching transistors 541 to 544. Level shifter circuits 545 are provided before gates of all the switching transistors 541 to 544 to adjust the levels of the drive signals I1 and I2. The level shifter circuits 545 may be omitted when not required.

The buffer module 540 inputs the two drive signals I1 and I2 from the PWM control module 530. The combination of the drive signal I1 at an H (high) level with the drive signal I2 at an L (low) level causes electric current to be flowed through the electromagnetic coil 180 in a first current direction IA1. This electric current is hereafter referred to as ‘bias high current’. In this state, a downward force is applied to the second magnet 110b (see FIGS. 6A and 6B) to enhance the shock-absorbing performance. The combination of the drive signal I1 at the L level with the drive signal I2 at the H level, on the other hand, causes electric current to be flowed through the electromagnetic coil 180 in a second current direction IA2. This electric current is hereafter referred to as ‘bias low current’. In this state, an upward force is applied to the second magnet 110b to weaken the repulsive force of the two magnets 110a and 110b.

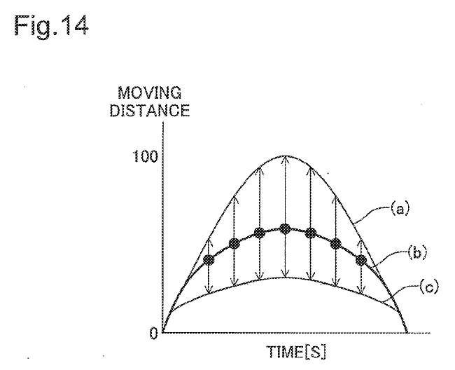

FIG. 14 is a graph showing variations in shock-absorbing performance with regard to the bias high current and the bias low current. Curves (a), (b), and (c) respectively show variations in moving distance of a magnet against a certain shock under application of the bias low current through an electromagnetic coil, under application of no electric current through the electromagnetic coil, and under application of the bias high current through the electromagnetic coil. The selective application of the bias high current and the bias low current effectively controls the strength of the resistance force used to absorb the shock. The combination of the drive signal I1 at the L level with the drive signal I2 at the L level does not make any electric current flow through the electromagnetic coil 180 and uses only the repulsive force of the two magnets 110a and 110b to absorb the shock. Power storage control discussed below is active in the state of both the drive signals I1 and I2 at the L level.

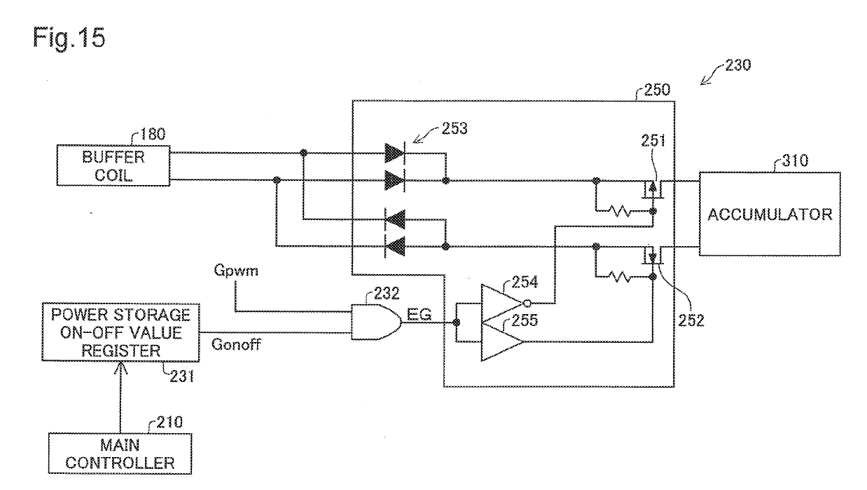

FIG. 15 is a circuit diagram showing the internal structure of the power storage controller 230. The power storage controller 230 functions to regenerate the electric power generated in the electromagnetic coil 180 at the H level of the power storage enable signal Gpwm. The power storage controller 230 includes a rectifier circuit 250, a power storage on-off value register 231, and an AND circuit 232. The rectifier circuit 250 has two gate transistors 251 and 252, a full-wave rectifier circuit 253 including multiple diodes, an inverter circuit 254, and a buffer circuit 255. The gate transistors 251 and 252 have output terminals connected to the accumulator 310.

The main controller 210 sets a power storage on-off value Gonoff for specifying power storage or non-power storage in the power storage on-off value register 231. The AND circuit 232 performs an AND operation to compute a logical product of the power storage on-off value Gonoff and the power storage enable signal Gpwm (see FIGS. 11A-11E) and outputs the logical product as a power storage interval signal EG to the inverter circuit 254 and to the buffer circuit 255.

Under the power storage control, the electric power generated in the electromagnetic coil 180 is rectified by the full-wave rectifier circuit 253. The power storage interval signal EG and its inversion signal are supplied to the respective gates of the gate transistors 251 and 252 to control on and off the gate transistors 251 and 252. The regenerated electric power is accumulated in the accumulator 310 in an H-level interval of the storage interval signal EG. Regeneration of electric power is prohibited in an L-level interval of the storage interval signal EG.

As discussed above, in the shock-absorbing power generation apparatus 300 of the seventh embodiment, the presence of the power storage controller 230 and the accumulator 310 enables the electric power generated by a shift of the magnet 110b in the shock-absorbing operation to be accumulated in the form of electrical energy. This arrangement allows switchover between the control of producing a force from the electromagnetic coil 180 and the control of accumulating electric power generated by the electromagnetic coil 180 into the accumulator 310.

As shown in FIGS. 11B through 11E, the drive signal I1 (or the drive signal I2) is exclusive to the power storage enable signal Gpwm. In an H-level interval of the drive signal I1 (or the drive signal I2), the electric current may be supplied to the electromagnetic coil 180 to adjust the shock-absorbing performance. In an L-level interval of the drive signal I1 (or the drive signal I2), the power storage enable signal Gpwm may be used for accumulation of electric power. This arrangement allows switchover between and parallel implementation of the adjustment of the shock-absorbing performance and the accumulation of electric power. In such parallel operations, it is preferable to provide a short rest interval where both the drive signal I1 (or the drive signal I2) and the power storage enable signal Gpwm are at the L level between the H-level interval of the drive signal I1 (or the drive signal I2) and the H-level interval of the power storage enable signal Gpwm.

### E. Modifications

The embodiments discussed above are to be considered in all aspects as illustrative and not restrictive. There may be many modifications, changes, and alterations without departing from the scope or spirit of the main characteristics of the present invention. Some examples of possible modification are given below.

### E1. Modified Example 1

In the shock absorbers of the respective embodiments discussed above, the permanent magnets have the ring-like shape. This shape is, however, neither essential nor restrictive. The permanent magnets may be formed to have any other suitable shape, for example, a columnar shape or a quadratic prism shape.

### E2. Modified Example 2

In the shock absorbers of the respective embodiments discussed above, two end magnets at respective ends of multiple magnets are permanent magnets. In one modification, one of the two end magnets may be an electromagnet and the other may be a permanent magnet. For example, one end magnet fastened to the magnet holder may be an electromagnet, and the other end magnet freely movable along the vertical axis in the magnet holder may be a permanent magnet.

### E3. Modified Example 3

When the electromagnet is applied for at least one of the two end magnets as explained in Modified Example 2, one preferable modification controls both the amount of electric current supplied to the electromagnetic coil provided in place of the permanent magnet, as well as the amount of electric current supplied to the electromagnetic coil for generating a buffering force.

### E4. Modified Example 4

The shock absorber of the fifth embodiment uses one electromagnetic coil corresponding to one magnet between the two magnets. The shock absorber of the sixth embodiment uses two electromagnetic coils corresponding to two magnets among the three magnets. The number of electromagnetic coils is, however, not restricted to the structures of these embodiments but may be set arbitrarily as long as M electromagnetic coils are provided corresponding to M magnets out of N magnets, where M is an integer of not less than 1 but not greater than N. For example, only one electromagnetic coil may be provided corresponding to only one magnet among three magnets.

### E5. Modified Example 5

In the shock absorbers of the respective embodiments discussed above, with the purpose of varying the resistance force of the shock absorber and accumulating electric power, the main controller supplies the following signals and parameters to the drive controller and to the power storage controller to specify their operating conditions:
(1) resistance value Rv (FIGS. 8A and 8B);
(2) buffer bias direction value RI (FIGS. 11A-11E);
(3) command value Ya (FIGS. 12); and
(4) power storage on-off value Gonoff (FIG. 15).

One modified structure of the shock absorber may specify only part of these signals and parameters, based on one or more input values.

### E6. Modified Example 6

In the shock absorber of the seventh embodiment, the command value setting module sets the command value M to be supplied to the PWM control module. The command value M may alternatively be a fixed value. In this modified application, the position sensor is not required.

What is claimed is:

1. A shock absorber, comprising:
N magnets arranged such that like poles of adjacent magnets face each other to generate repulsive force, where N is an integer of at least 2;
a magnet holder that accommodates the N magnets in absorbing direction such that a distance between the adjacent magnets is variable so that the shock absorber absorbs a shock applied to two end magnets disposed at respective ends of the N magnets;
a coil unit including at least one electromagnetic coil located on at least either of an outer circumference part and an inner circumference part of the N magnets bank; and
a controller that controls an electrical operation of the coil unit including a drive controller and a power storage controller, wherein the drive controller performs a drive control operation of supplying electric current to the coil unit to vary a shock-absorbing performance of the shock absorber, wherein the power storage controller performs a power storage control operation by using electric power generated in the coil unit caused by movement of at least one magnet out of the N magnets,
wherein the controller executes a changeover between the drive control operation and the power storage control operation, and provides a short rest interval time between the drive control operation time and the power storage control operation time.

2. The shock absorber according to claim 1, wherein N is an integer of at least 3, and the N magnets include at least one middle magnet disposed between the two end magnets of the N magnets and arranged such that opposite poles of the middle magnet face corresponding poles of adjacent magnets to generate repulsive forces.

3. The shock absorber according to claim 1, wherein one of the two end magnets of the N magnets is an electromagnet, and the other of the two end magnets is a permanent magnet.

4. The shock absorber according to claim 1, wherein the coil unit includes M electromagnetic coils associated with M magnets selected out of the N magnets, where M is an integer between 1 and N, inclusive.
